(19) United States
(12) Patent Application Publication
(10) Pub. No.: US 2026/0057715 A1
(43) Pub. Date: Feb. 26, 2026

(54) SYSTEM AND METHOD FOR SECURELY EXTRACTING AND TRANSMITTING DIAGNOSTIC SCAN RESULTS AND CHAIN OF CUSTODY

(71) Applicant: Joseph Michael Sieger, Carrollton, TX (US)

(72) Inventor: Joseph Michael Sieger, Carrollton, TX (US)

(21) Appl. No.: 19/012,312

(22) Filed: Jan. 7, 2025

Related U.S. Application Data
(60) Provisional application No. 63/685,853, filed on Aug. 22, 2024.
(60) Provisional application No. 63/705,137, filed on Oct. 9, 2024.

(51) Int. Cl. G07C 5/08; G07C 5/00

(52) U.S. Cl. CPC G07C 5/0825; G07C 5/008; G07C 5/0808; G07C 5/085; G07C 2205/02

(57) ABSTRACT

Briefly, one or more embodiments are direct to a process, system, and article for transmitting a request for a diagnostic scan of a vehicle from a diagnostic application running on a computing device to an On-Board Diagnostic (OBD) system of a vehicle. A file may be received, by the diagnostic application, from the OBD system of the vehicle in response to the OBD system performing the diagnostic scan. The diagnostic application may launch a web browser application to display results stored in the file. A web browser extension of the web browser application may copy the file to generate a file copy. The file copy may be transmitted by the web browser extension to a diagnostic test results database.

### CROSS-REFERENCE

The present invention is a non-provisional application claiming priority to both provisional application No. 63/685,853 filed on Aug. 22, 2024, and to provisional application No. 63/705,137 both filed on Oct. 9, 2024, incorporated by reference herein in its entirety.

### BACKGROUND

If an automobile is in an accident or otherwise is damaged, the owner of the automobile typically takes the automobile to a workshop, such as an autobody shop, automobile dealer, or some other entity which handles or performs repairs as needed. In some instances, the automobile is capable of being repaired, but in other instances, the cost of repairing the automobile is prohibitively expensive, in which case the automobile may be scraped or sold for its parts. For example, even if the automobile suffers extensive damage to its chassis during a traffic accident, some of the electrical components or other components within the automobile may still be in working condition and may be removed and reused in a different automobile.

A workshop may perform a diagnostic scan on a vehicle to determine the extent of damage to a vehicle and which parts are needed in order to perform a repair. Similarly, the diagnostic scan may indicate that that the amount of damage is to such an extent that the cost to repair the automobile is too great and that the automobile should instead be sold for scrap or have any remaining useable parts removed or harvested for use in other automobiles.

If the automobile has been damaged to the extent that it would not be cost-effective to repair the automobile, the automobile may be sold to an auto parts dismantler. For example, if the damaged automobile is insured by an insurance company, the owner of the damaged automobile may file a claim for the damage with his or her insurance company. The insurance company may inspect the automobile to determine the extent of damage, such as through the use of a workshop where a technician may run diagnostic tests on the automobile to determine which control or electrical systems are damaged within the automobile. If the insurance company decides that the automobile is not worth repairing, the insurance company may pay out the claim to the holder of insurance for the automobile and may take possession of the damaged automobile. The insurance company may thereafter sell the automobile to a third party, such as at a salvage auction. For example, damaged automobiles are often purchased at salvage auctions for their parts, such as for items on the body of the automobile, including hoods, doors, bumpers, gas tanks, and various internal circuitry for control systems of the automobile, to name just a few examples among many. After a third party, such as a dismantler, purchases the automobile at a salvage auction, the dismantler may run diagnostic scans of control systems of the vehicle to determine which electronic components of the automobile are functioning properly and may be used in other automobiles, for example.

Each year there are millions of automobiles which are purchased at salvage auctions. Currently, a human technician may run various diagnostic tests on an automobile purchased at a salvage auction to determine which control systems or electronic circuitry are still in usable condition. In the event that the result of diagnostic tests are displayed to a user, such as through a graphical user interface, the technician has no simple way in which to add the results of the diagnostic tests to a database other than by manually inputting, such as by typing via a keyboard, the results of the diagnostic tests into various reports or other documents to be stored in a database.

Even if a user has the option to email an attachment of a diagnostic scan results to him- or herself, there is often a chance that the email will be caught in an email program's spam filter, potentially without the user being aware of the email being labeled as spam. Moreover, even if the user does receive such an email, the user has no easy way for which to add the content of the attachment into a database.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of some entities involved in vehicle repair and salvage.

FIG. 2 illustrates an OBD2 (On-Board Diagnostics II) scanner according to an embodiment.

FIG. 3 illustrates an embodiment of some entities involved in vehicle repair and salvage.

FIG. 4 illustrates an embodiment of a system for performing a diagnostic scan of a vehicle and reporting the results to a diagnostic scan results database.

FIG. 5 illustrates an embodiment of a system for initiating a diagnostic scan on a vehicle and transmitting the results of the diagnostic scan to a diagnostic results database via use of a web browser extension of a web browser.

FIG. 6 illustrates an embodiment of a flow diagram for acquiring diagnostic scan results of a vehicle and using a web browser extension to transmit the diagnostic scan results to a diagnostic scan results database.

FIG. 7 illustrates an embodiment of a system for initiating a diagnostic scan on a vehicle from a tablet and transmitting the results of the diagnostic scan to a diagnostic results database via use of a web browser extension of a web browser.

FIG. 8 illustrates an embodiment of a view of a display screen of a tablet.

FIG. 9 illustrates a display window of a licensed diagnostic application.

FIGS. 10-13 illustrate embodiments of a window of a web browser displayed on a tablet.

FIGS. 14A and 14B collectively illustrate an embodiment of a flow diagram for acquiring diagnostic scan results of a vehicle, accessing the diagnostic scan results in a web browser remote from a licensed diagnostic application, and using a web browser extension to copy and transmit at least a portion of the diagnostic scan results to a diagnostic scan results database.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments, as discussed herein, are directed to a process for using an extension of a web browser application to automatically capture results of diagnostic tests performed on one or more systems of an automobile. “Web browser application” and “web browser” are used interchangeably herein. For example, a technician at a car dealer or vehicle workshop may initiate the performance of various diagnostic tests on systems of the vehicle. The results of such diagnostic tests may be presented to the technician in a web browser of a graphical user interface, such as on a laptop, desktop computer, portable tablet, or smart phone, to name just a few examples among many. The results may be presented in an organized format and may indicate the names, part numbers, and serial numbers of various electronic components, as well as the status of such electronic components, such as indicating whether individual electronic components are in working condition or need replacement or repair. A web browser extension may automatically copy or otherwise capture the results presented via the web browser and may transmit the results to a database or server. By transmitting the results in this way, the status and condition of parts within the vehicle may be stored in a centralized location so that the usable parts may be harvested or otherwise extracted from the vehicle for use in a different vehicle at a later date. Moreover, the origin of the parts may also be known so that if various individual parts are harvested, the source vehicle from which those parts were acquired may be known.

The use of a web browser extension to automatically copy or otherwise acquire the results of diagnostic tests for a vehicle displayed in a corresponding web browser and transmit such results to a database provides a significant improvement in efficiency in itemizing serviceable electronic components of a vehicle. For example, instead of a technician initiating the performance of diagnostic tests and then the technician manually typing the results of the diagnostic tests into documents for upload to a database, the automated captured and upload of the results through the use of a web browser extension may greatly reduce the amount of human interaction required to provide such information to the database. Moreover, the incident of human error, such as by a human operator manually typing the wrong information into a document to upload to the database, may be either eliminated entirely or otherwise greatly reduced.

Another advantage of embodiments discussed herein relates to platform independence of a web browser. For example, General Motors™ vehicles may require use of a particular set of diagnostic tests and associated diagnostic test codes which are presented in a dedicated General Motors™ application or portal accessible via a web browser, and which may only be in communication with a General Motors™ server. Similarly, Mazda™ vehicles may require use of a particular set of diagnostic tests and associated diagnostic test codes which are presented in a dedicated Mazda™ portal accessible via a web browser, and which may only be in communication with a Mazda™ server. However, by using a web browser extension, as discussed herein, the information presented on both the General Motors™ portal and the Mazda™ portal via a web browser may be automatically copied or captured by a web browser extension for transmission to a database operated by a third party which is unrelated to General Motors™ or Mazda™ in this particular example.

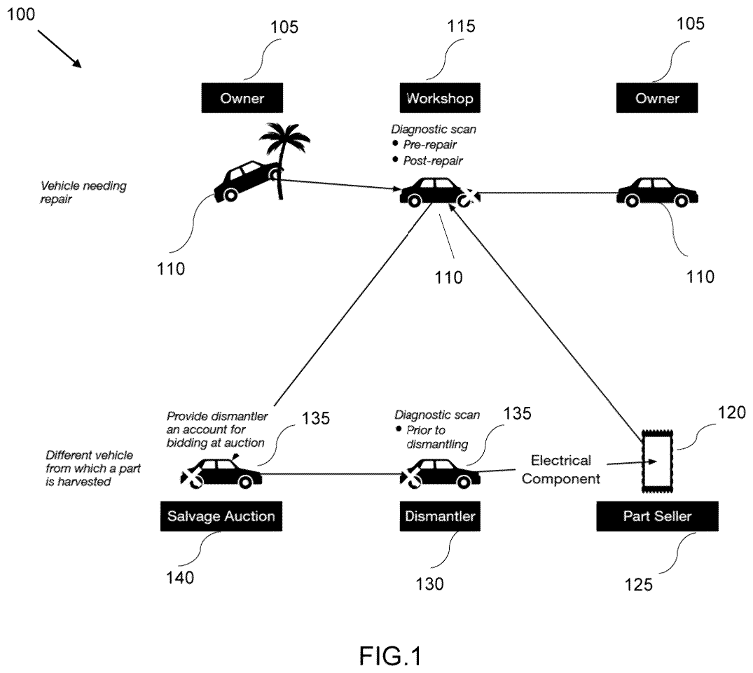

FIG. 1 illustrates an embodiment 100 of some entities involved in vehicle repair and salvage. As shown, an owner 105 of a first vehicle 110 may be involved in an accident or may have some other type of loss event after which the first vehicle 110 is in need of repair. A workshop 115 may be given custody of the first vehicle to determine whether the first vehicle 110 is capable of being repaired. For example, the owner 105 may either drive the first vehicle 110 to a workshop 115 or the first vehicle 110 may be towed to the workshop or end up at the workshop 115 some other way. A technician at the workshop 115 may perform a pre-repair diagnostic scan of the first vehicle 110 to determine what components and/or systems of the first vehicle are damaged or otherwise in need of repair or replacement. A diagnostic scan on a vehicle may be performed by connecting a specialized tool, called an OBD2 (On-Board Diagnostics II) scanner, to the vehicle's Diagnostic Link Connector (DLC) which allows access to the car's computer or OBD system. A DLC comprises a multi-pin diagnostic connection port for automobiles, trucks, and motorcycles used to interface an OBD2 scanner with the control modules of a given vehicle and access on-board diagnostics and live data streams. A DLC is often located under the instrument panel on the driver side. The instrument panel is a portion of the dashboard which sits behind the steering wheel of first vehicle 110. The instrument panel comprises a control panel that displays information about the first vehicle's 110 status and performance.

OBD is a system that monitors the first vehicle's 110 computer system and reports diagnostic trouble codes. If an automobile is brought to a workshop for potential repairs, a workman may connect an OBD2 scanner to the vehicle's DLC to prompt the vehicle's OBD system to perform various tests. For example, the OBD2 scanner may prompt the OBD system to ping or contact every control system in the first vehicle 110 to determine whether any of the control systems or electrical components exist or are malfunctioning. In the event that one or more of the control systems or electrical components is not functioning properly, a trouble code for a faulty control system or faulty electronic component may be transmitted to the OBD2 scanner so that the trouble code may be displayed to a workman.

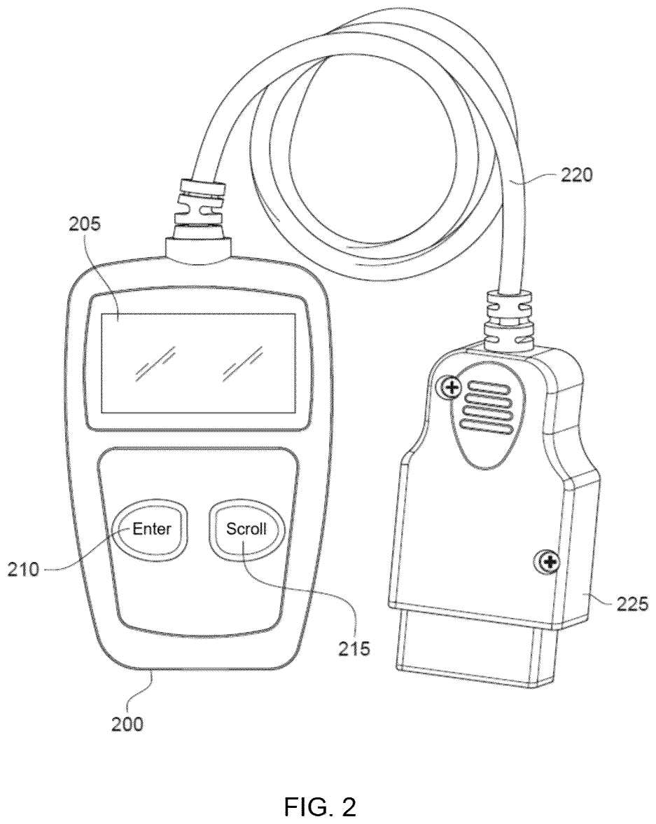

FIG. 2 illustrates an OBD2 scanner 200 according to an embodiment. As shown, OBD2 scanner 200 may comprise a handheld mobile device which includes a display 205, one or more input buttons or keys, such as enter button 210 and a scroll button 215, to name two examples of buttons or keys on an OBD2 scanner. In some embodiments, OBD2 scanner 200 may include a keypad or may be capable of being coupled to a keypad, keyboard, and/or some other user input device to receive user inputs. OBD2 scanner may include or be coupled to a plug 225 via a cord 220. Plug 225 may be detachable connected to a vehicle's DLC to initiate a diagnostic scan and/or to receive the results of such a diagnostic scan of the vehicle. For example, if there are any detected faulty components of a control system or electrical components of the vehicle, one or more trouble codes may be presented to a technician via display 205. In some embodiments, an explanation each detected trouble code may also be presented on display 205.

An ODB scanner 200 may obtain an identifier of the first vehicle 110 when connected to the vehicle's DLC. The OBD2 scanner 200 may also determine all of the modules of the first vehicle 110. A “module,” as used herein, refers to an electrical component, computing device, or computer that controls a specific function or set of functions in a vehicle. New cars often have more than 30 different modules within them. Examples of commonly used modules include an engine control module which manages the vehicle's engine's performance by monitoring sensors and adjusting fuel injection, ignition timing, and other functions. A transmission control module may manage shifting, particularly in automatic transmissions. A powertrain control module may combine the functions of the engine control module and transmission control module into one unit. A brake control module may control a vehicle's wheels and braking system. A door control unit module may control the doors of the vehicle. An electric power steering control unit module may control an electric power steering system of the vehicle. A human-machine interface module may enable a human operator to interact with a machine or system of the vehicle. A seat control unit module may control the seats of the vehicle. A speed control unit module may control the speed of the vehicle. A telematic control unit module may manage telematics services, essentially acting as a communication hub to collect, process, and transmit data about the vehicle's location, performance, and driver behavior to external systems, enabling features like vehicle tracking, emergency call systems, and driving analysis. A battery management system module may monitor the state and health of one or more batteries of the vehicle.

Referring back to FIG. 1, after performing a pre-repair diagnostic scan, the results of the scan may be presented to a technician at workshop 115. For example, an ODB scanner 200 may read data from various sensors and components to identify any malfunctions or error codes, essentially providing a detailed analysis of the car's health and pinpointing potential problems by interpreting the stored codes displayed on a display of ODB scanner. Results of the diagnostic scan may include learning the identification number of an electrical component 120 in a circuit or system or a diagnostic trouble code from a damaged or faulty circuit or system. After performing the pre-repair diagnostic scan, the workshop 115 may provide results of the diagnostic scan to owner 105 and may inform the owner 105 whether the first vehicle 110 should be repaired, or whether the extent of damage to first vehicle 110 is so great that repair would be prohibitively expensive. In the event that a decision is made to repair the first vehicle 110, the workshop 115 may contact a part seller 125 to obtain or otherwise order the replacement electrical component for use in the first vehicle 110. Part seller 125 may maintain an inventory of vehicle parts which have been harvested from or otherwise acquired by a dismantler 130. A dismantler 130 may comprise a component or other entity which purchases vehicles, such as a second vehicle 135 from a salvage auction 140. Many vehicles use specialized electronic components which may not be readily available in brand new condition. For example, there may be a controller which is only used within BMW™ vehicles of a particular model sold in a particular year and which may not currently be manufactured. In some instances, the controller may still be manufactured, but as a result of supply chain disruptions, a new replacement controller may not be available for an extended period of time, potentially months. Moreover, if the controller is only manufactured overseas, there may also be delays introduced while shipments of replacement controllers wait to go through Customs inspections at a port of entry, for example. Accordingly, instead of waiting for a potentially extended period of time for a newly manufactured replacement controller to be received for replacement of a damaged component, a replacement controller which has been in use and still has a serviceable lifespan may instead be acquired from an existing vehicle. For example, if a vehicle has incurred extensive damage to a body or engine but diagnostic tests reveal that at least some of the electrical or electronic components of the vehicle are still functioning properly, such electronic components may be harvested from the damaged vehicle and used as replacement electronic components for a different vehicle which is being repaired. In the embodiment shown in FIG. 1, dismantler 130 may run a diagnostic scan on second vehicle 135 after purchasing or otherwise acquiring the second vehicle 135 from the salvage auction 140. The diagnostic test may be performed to learn the identification number of an electrical component in a circuit or system or to learn there the circuit or system has no diagnostic trouble code indicating the electrical component might not work Dismantler 130 may maintain an inventory of serviceable components harvested from second vehicle 135 as well as from other vehicles purchased from salvage auction 140 or otherwise acquired some other way. Dismantler 130 may sell electrical component 120 to part seller 125 and part seller 125 may, in turn, sell electrical component 120 to workshop 115 to replace a damaged electrical component of first vehicle 110. After workshop 115 repairs first vehicle 110 by replacing the damaged electrical component with the electrical component 120 acquired from part seller 125, the workshop 115 may perform a post-repair diagnostic scan to confirm the repair before custody of the vehicle is given to the owner 105. In some embodiments, a single entity may comprise both the dismantler 110 and the part seller 125.

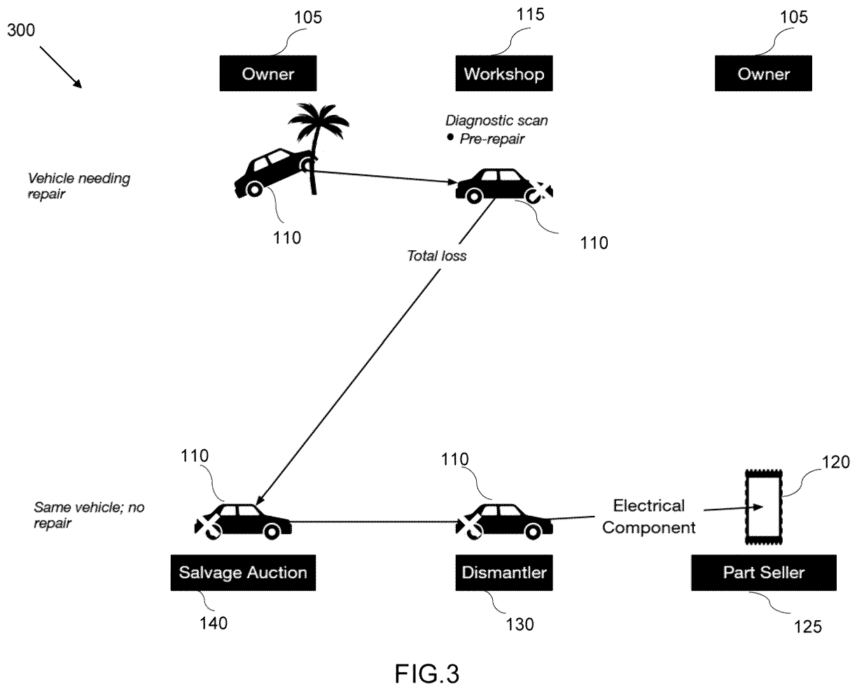

FIG. 3 illustrates an embodiment 300 of some entities involved in vehicle repair and salvage. Embodiment 100 of FIG. 1 is directed to an embodiment in which a first vehicle 110 is capable of being repaired in an economic manner. If, however, a diagnostic scan on first vehicle 110 to inspect the health of the first vehicle 110 indicates that repair would be prohibitively expensive, the first vehicle 110 may instead be sold to salvage auction, such as is shown in embodiment 300 of FIG. 3. As shown, workshop 115 may run a diagnostic scan on first vehicle 110 before performing any repairs. In embodiment 300, workshop 115 may determine that the first vehicle 110 would be prohibitively expensive to be repaired and should instead be considered a total loss to the owner 105 of the first vehicle 110. Accordingly, in practice, owner 105 may file an insurance claim with the insurance company which provides automobile insurance for first vehicle 110. In this example, the insurance company may take possession of the first vehicle 110 and compensate the owner 105 for the total loss of first vehicle 110. In order to offset the compensation paid to owner 105, the insurance company may either sell the first vehicle 110 outright to salvage auction 140 or may instead sell the first vehicle to a third party via an auctioning process performed by salvage auction 140. In other words, custody of the first vehicle 110 may be provided to salvage auction 140. Salvage auction 140 may facilitate the sale of first vehicle 110 to dismantler 130, who may thereafter take custody of the first vehicle 110. Dismantler 130 may perform its own diagnostic scan on first vehicle 110 to determine which electrical components are still working or functioning properly. Dismantler 130 may also manually inspect a body of first vehicle 110 to determine which other components of the first vehicle 110 appear to still be usable, such as hub caps or wheels, to name just a couple examples among many. After performing a diagnostic scan, dismantler 130 may harvest various electrical components determined to be usable, such as within a different vehicle. After harvesting such electrical components, a particular item, such as electrical component 120 may be sold to or custody thereof is otherwise provided to part seller 125. For example, part seller 125 may comprise an intermediary who purchases electronic components from dismantler 130 and sells such electronic components, such as electronic component 120, to various workshops for installation or use within other vehicles being repaired. In some implementations, dismantler 130 and part seller 125 may comprise the same entity.

As discussed above with respect to embodiment 100 of FIGS. 1 and 300 of FIG. 3, the results of a diagnostic scan performed by workshop 115 may be used to determine procedures to repair first vehicle 110 if it determined that the first vehicle 110 is capable of being repaired economically, for example. Results of the diagnostic scan by workshop 115 may also be used to merchandise the first vehicle 110 for sale for its electrical components or other parts, such as in the event that a determination is made that it would not be economical to repair the first vehicle 110.

The results of a diagnostic scan of first vehicle 110 may include an identification (“ID”) number of an electrical component in a circuit or system at the time the diagnostic scan is performed. The results may also include a Diagnostic Trouble Code of an electrical component in a circuit or system at time scan is performed. A Diagnostic Trouble Code, or “DTC,” as used herein, refers to a code that identifies and communicates a vehicle's problems to technicians.

There are benefits to an entity considering taking custody of a vehicle, or an electrical component therefrom, from knowing the entity(ies) that previously had custody at prior times. Such benefits include a reduced risk that the electrical component has an unintended identification number (e.g., is the wrong part) or is in unintended condition (e.g., causes an unexpected diagnostic trouble code when placed into a circuit or system). Another benefit is an increased accuracy of predicting the electrical component's identification and condition. For example, when a vehicle is for sale at a salvage auction 140, there is less risk to dismantler 130 if the dismantler 130 knows the seller is an insurance company and the vehicle had a collision in its rear-end than when nothing is known about the source of the vehicle, its damage, or events preceding. In this example, if it is known that the vehicle has been damaged as a result of a rear-end collision, there is a likelihood that there are electrical components within the front portion of the car, such as in or near the engine block, which are likely to have been unaffected by the rear-end collision in many instances.

Moreover, if it is known that the vehicle is an insurance company, it is likely that the vehicle was in working condition prior to being sold at auction because the insurance company would have been unlikely to take custody of the vehicle and pay out a claim to the owner of the vehicle unless the insurance company had determined that the vehicle was working properly prior to the rear-end accident. For example, the vehicle might be considered to be more likely to have its original parts as compared to certain other sellers who are not insurance companies.

Information about the previous owner of the vehicle and the results of a diagnostic scan may be available to dismantler 130 through disclosures provided by salvage auction 140. For example, in order to bid on a damaged vehicle at auction, a buyer may be required to set up an account with salvage auction 140. If a potential buyer desires to bid on a vehicle up for auction by salvage auction 140, the potential buyer may access a web page through the account, where various known information about the vehicle, such as results of a diagnostic scan and prior ownership, or custody of the vehicle may be presented. Other beneficial information about the vehicle may include, but is not limited to, data about the vehicle title, odometer, damage, features, seller name, vehicle condition, loss type, images, and dates of custody.

As another example, when a part seller 125 sells an electrical component 120 in used condition under the brand of a third party, or endorsed by a third party, the third-party benefits (e.g., protects its brand) when there is an audit trail for chain of custody for the electrical component.

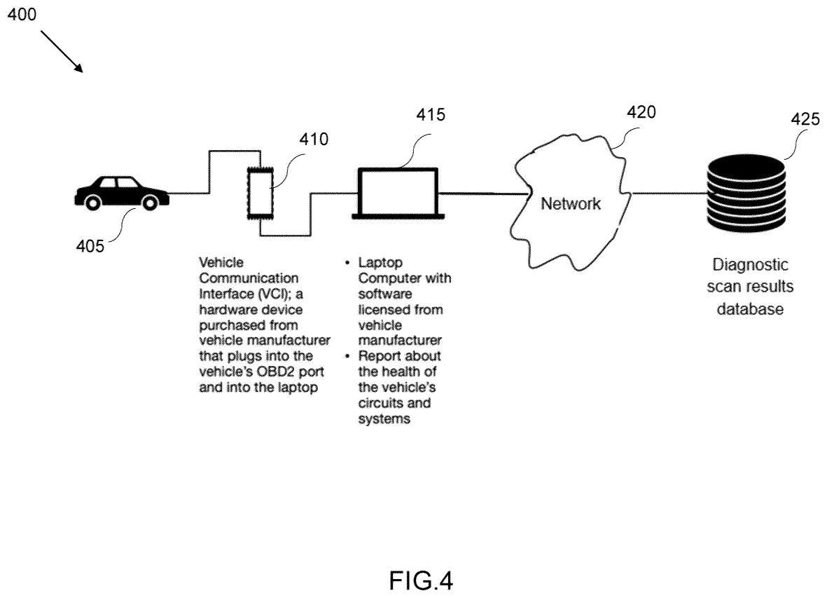

FIG. 4 illustrates an embodiment 400 of a system for performing a diagnostic scan of a vehicle 405 and reporting the results to a diagnostic scan results database 425. As illustrated, a diagnostic scan may be performed on vehicle 405. For example, a laptop computer 415 may include or have installed thereon a software application for initiating a diagnostic scan or diagnostic tests on vehicle 405, in a manner similar to OBD2 scanner 200 as shown in FIG. 2. Laptop computer 415 may have software installed thereon from a manufacturer of vehicle 405. Laptop computer 415 may interface with a DLC of vehicle 405 via a Vehicle Communication Interface (VCI) 410. A VCI 410, as used herein, refers to a hardware component which allows a vehicle's electronic control units (ECUs) to communicate with external devices and diagnostic applications. An ECU, as used herein, refers to a typically small, computerized or electrical component that manages one or more systems within a vehicle by receiving data from sensors or other ECUs throughout the vehicle, processing the data, and then sending signals to actuators to adjust different functions, essentially acting as the “brain” of a modern automobile, controlling everything from engine performance and transmission to safety features like airbags and even comfort features such as power windows and climate control.

VCI 410 may plug into an OBD2 port of vehicle 405 on one end, and the other end may be coupled to laptop computer 415, such as through wired connection or through a wireless connection, such as via BlueTooth™. Through use of VCI 410, an application running on laptop computer 415 may initiate a diagnostic scan of vehicle 405 and may generate a report about the health of the vehicle's 405 circuits and systems. The report may be presented on laptop computer 415 within a web browser. A “web browser,” as used herein, refers to software application that allows users to access and view content on the internet. A web browser may fetch content, such as from a web server, and display the content within a graphical user interface of a computing device. In embodiment 400, when a technician utilizes laptop computer 415 to initiate a diagnostic scan of vehicle 405, results of the diagnostic scan may be displayed within a web browser presented on a graphical user interface of laptop computer 415. For example, the results of the diagnostic scan may be stored locally on laptop computer 415 without being sent to a server for the application program.

In accordance with a particular embodiment, the application used to initiate the diagnostic scan may receive the results of the diagnostic scan from the VCI 410. In one implementation, the application may generate a file which includes the results of the diagnostic scan, and that file may be stored in a storage location of the laptop computer 415, such as in a temporary storage area. After storing the file of results from the diagnostic scan in storage of the laptop computer 415, the application may prompt a web browser of the laptop computer 415 to open and the results of the diagnostic scan to be displayed within a window of the web browser. For example, the file of results may comprise a HyperText Markup Language (HTML) file.

One reason why a diagnostic report would be presented in a web browser instead of in a custom graphical user interface is because it may be simpler for the provider of the application program which is used to initiate the diagnostic scan. For example, instead of a programmer having to generate a custom display interface and display screens, results of a diagnostic scan may instead be presented within a web browser, potentially reducing the amount of coding and customization which might otherwise be required.

After results of the diagnostic scan are displayed in a web browser of laptop computer, a web browser extension may copy or otherwise capture the information displayed in the web browser and may transmitted the copied information via a network 420, such as the Internet, to a diagnostic scan results database 425. In such an embodiment, diagnostic scan results may be copied or captured from a web browser via a web browser extension and transmitted to databased operated by a third party which is unrelated to and has no contractual relationship with the provider of the application program running on laptop computer 415 which initiated the diagnostic scan. A “web browser extension,” as used herein refers to a software module for customizing a web browser. A web browser may enable a user to install a variety of extensions, including user interface modifications, cookie management, ad blocking, and the custom scripting and styling of web pages. A web browser extension as used with respect to embodiment 400 of FIG. 4, may copy or “scrape” data from a webpage on which diagnostic scan results are displayed and may transmit or send such copied data to diagnostic scan results database 425. By using a web browser extension to copy diagnostic scan results for vehicle 405 and transmit a diagnostic scan results database 425 as discussed herein, various benefits may be realized. For example, diagnostic scan results database 425 may receive diagnostic scan results from a variety of vehicles from different manufacturers without having to have a license or other contractual relationship with the owner of the application program which initiated a diagnostic scan of a vehicle or displayed the results to a user. Moreover, diagnostic scans of vehicles are performed potentially hundreds of thousands of times daily throughout the world and if the results of a relatively large percentage of such diagnostic scans could be copied and sent to a diagnostic scan results database 425, valuable insights may be realized, such as predicting the existence, identity, or condition of an electrical or electronic component and/or system. Moreover, information about the health of electrical or electronic systems or components of vehicles may also be determined and stored in a centralized location, in this case, within diagnostic scan results database 425.

It should be appreciated the diagnostic scan of vehicle 405 may be initiated by a workshop determining whether to repair vehicle 405, prior to initiating such repairs. The diagnostics scan may also, or alternatively, be initiated by a dismantler who has obtained vehicle 405 from a salvage auction. Regardless of which entity initiates the diagnostic scan, the results may be transmitted to diagnostic scan results database 425. It should also be appreciated that although embodiment 400 shows the use of a laptop computer 415 for initiating a diagnostic scan, other types of computing devices may initiate the diagnostic scan in some embodiments, such as a desktop computer, smartphone, electronic tablet, to name just a few examples among many. Moreover, information presented in any device capable of presenting a web browser capable of employing a web browser extension may be copied or captured and transmitted of diagnostic scan results database 425.

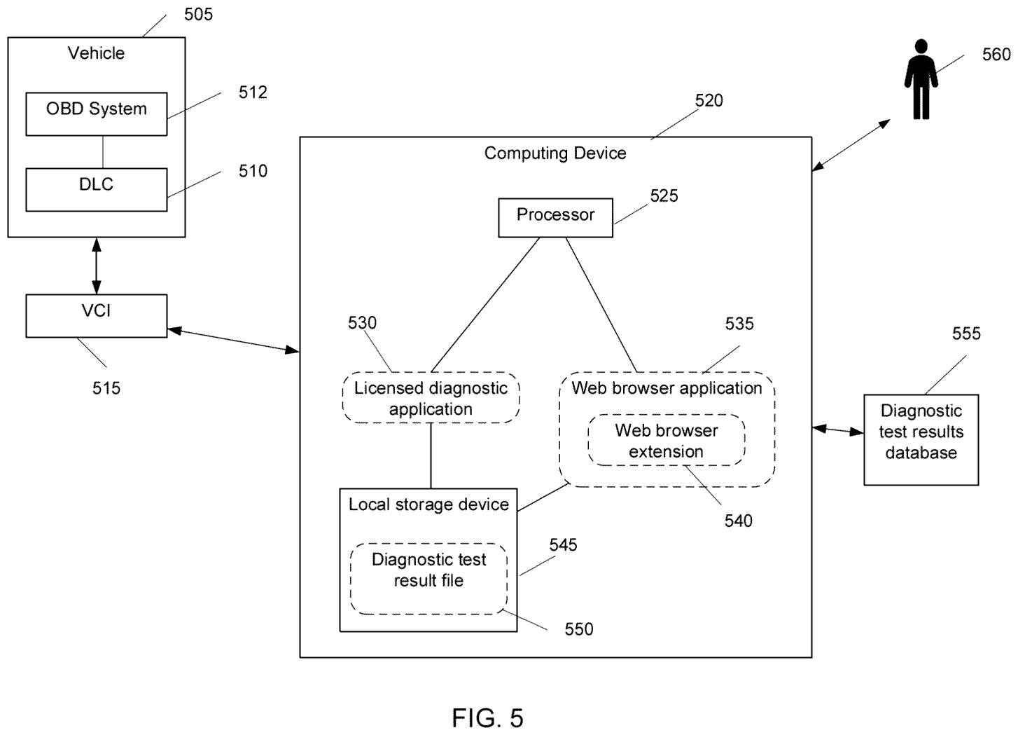

FIG. 5 illustrates an embodiment 500 of a system for initiating a diagnostic scan on a vehicle 505 and transmitting the results of the diagnostic scan to a diagnostic results database 555 via use of a web browser extension 540 of a web browser 535. A user 560, such as a technician may utilize a computing device 520, such as a laptop computer, a desktop computer, a smart phone, smart tablet, or any other computing device capable of running a web browser 535, for example. User 560 may cause computing device 520 to launch a licensed diagnostic application 530, such as an application specific to a certain vehicle manufacturer such as a General Motors, Ford, or Honda, to name just a few examples among many. For example, if vehicle 505 is a General Motors automobile, licensed diagnostic application 530 may be dedicated for use with General Motors automobiles. User 560 may provide one or more user inputs via licensed diagnostic application 530 to cause VCI 515 to provide a request for a diagnostic scan to an On-Board Diagnostic (OBD) system 512 via a DLC 510 of vehicle 505. Results of the requested diagnostics scan of vehicle 505 may be transmitted from OBD system 512 from DLC 510 via DLC 510 and from VCI to licensed diagnostic application 530. As discussed above, licensed diagnostic application 530 may generate a diagnostic test result file 550, which may be stored in a local storage device 545 of computing device 520. Although local storage device 545 is illustrated as being internal to computing device 520, it should be appreciated that in some implementations, local storage device 545 may be external to, but still accessible by, computing device 520. After storing diagnostic test result file 550 in local storage device 545, licensed diagnostic application 530 may open a web browser 535 or, if the web browser 535 is already open, licensed diagnostic application 530 may open a new window within web browser 535. After opening the web browser 535, a new window thereof, the licensed diagnostic application 530 may cause or instruct the web browser 535 to display the information stored within the diagnostic test result file 550. Web browser extension 540 may monitor information, such as web pages, displayed or accessed via web browser 535 and may listen for a displayed file which has a predetermined format or naming structure. For example, various instances of diagnostic test result file 550 may include a predetermined character string. For example, a diagnostic test result file 550 for a General Motors™ automobile which has been scanned by General Motor's™ Global Diagnostic System (GDS) may have a predetermined character string such as “GDS” within the file name stored in local storage device 545. If a file or web page is displayed or otherwise accessed by web browser 535, web browser extension 540 may detect the use of the “GDS” within the file name and may automatically send a copy of the diagnostic test result file 550 to a diagnostic scan results database 555 for external storage, for example.

The use of a web browser extension 540 or browser add-on has various security benefits. For example, a web browser extension 540 may be obtained from a store authorized by a trusted party such as the Microsoft Edge™ Add-ons store or the Google Chrome Web Store™, providing various benefits, such as increased security for the underlying web browser 535 itself, better compatibility with a user's device, access to automatic updates, and a higher likelihood of quality control due to the strict review process implemented by the store operators, thereby minimizing the risk of malware or malicious applications. Moreover, installing a web browser extension 540 within a web browser 535 acquired from an authorized store offers enhanced security relative to an entirely separate application which performs the same copying operations as the web browser extension discussed above. For example, there is no need for a user to install a separate application to copy the information from the diagnostic test results file 550. Instead, as discussed above, a web browser extension 540 may be installed within a trusted web browser 535 to thereby piggyback off the security of the web browser 535 itself. Moreover, various compatibility and frequent application security patches or updates may be performed by the provider of the web browser 535 itself instead of a provider of a separate application.

In some implementations, a dismantler who intends to bid on a vehicle being sold by a salvage action entity may be provided with an account by the salvage auction, such that the dismantler is provided with a mechanism for submitting a bid for the vehicle. For example, the account may be used to provide certain information to the dismantler so that the dismantler may make an informed bid for the vehicle. Information about the vehicle may be provided from a salvage auction webpage to a database accessible by the user. For example, when the user's web browser application 535 is viewing a webpage of the salvage auction, the a web browser extension 540 may copy data indicating that the vehicle was in a rear end collision. This data may be useful in the event the user purchases the vehicle and subsequently wants to determine whether an electrical component in the front end of the vehicle should be deemed to be in good condition.

Information about the vehicle may also flow from the database to the user's web browser application 535 when viewing a salvage auction webpage. For example, when the user's web browser application 535 is viewing a webpage of the salvage auction, a web browser extension 540 may append a dollar sign emoji (e.g., “$”) to a vehicle record in the case where a vehicle potentially has a valuable electoral component, if the electrical component is later found to be in good condition or if the electrical component is known to be in good condition from an earlier diagnostic scan. The user may therefore be better informed about how high a price to bid at auction for the vehicle.

In some embodiments, when a user requests that a diagnostic scan be run on a vehicle 505, various questions relating to the vehicle may be asked before queries are sent to the various control systems if the vehicle 505. For example, after providing a user input to request that a diagnostic scan be run on vehicle 505, the user may be prompted to provide a user input relating to whether the vehicle 505 is front wheel drive or all-wheel drive. After the user has provided an answer to the question, the user may be prompted to provide a user input to another question, such as asking a question relating to the braking system of vehicle 505. The user may be prompted to answer several more questions before queries for the diagnostic scan are dispatched to the various modules of the vehicle 505. The questions may be presented to the user via a series of popup windows, for example. A reason why the user is prompted to answer such questions is because the answers to such questions may be relevant if the user intends to repair vehicle 505. However, if a dismantler has purchased or otherwise obtained vehicle 505 and intends to harvest usable electrical components from the vehicle 505, the answers to the questions may not have a bearing upon the usability of the electrical components and having to manually provide answers to a series of such questions may delay the start of the querying of controller system for the diagnostic scan.

In some embodiments, a Robotic Process Automation (RPA) feature may be employed to automatically provide answers to a series of questions asked prior to dispatching questions to control systems of vehicle 505 during a diagnostic scan. “Robot Process Automation” or “RPA,” as used herein, refers to a software technology that uses robots to automate repetitive tasks that are typically done by humans. For example, if a series of multi-choice questions are asked of the user, an RPA feature may automatically select one of the available answers to each question, such as the first displayed answer to each question, in order to speed up the process to initiate the dispatching of queries to the control system of vehicle 505. As discussed above, if a dismantler desires to run a diagnostic scan on vehicle 505 prior to harvesting usable electrical components, the particular answers to each question of the series of questions may not have any bearing or influence on the usability of any of the electrical components of vehicle 505. A web browser extension 540 may do more than copy data from a webpage and modify what is displayed on a webpage. For example, a web browser extension 540 may act like a robot and may also click a button, scroll, and perform other user interactions.

The use of robotic process automation has security benefits including but not limited to the use within a first party application and integration with a first party computer operating system. For example, an enhanced level of security may be achieved because Microsoft™ may develop and/or provide the RPA and certain diagnostic scan applications, such as one for General Motors™, may require the use of the Microsoft™ operating system and the Microsoft Edge™ browser application.

In some embodiments, web browser extension 540 may employ one or more Application Programming Interfaces (APIs) to transmit captured data or files to diagnostic scan results database 555. An “Application Programing Interface” or “API,” as used herein, refers to a set of rules and protocols that allow software applications to communicate with each other. In some embodiments, a user or technician may initiate a diagnostic scan of a vehicle and results of the diagnostic scan may be directed sent, via an API of web browser extension 540, to diagnostic scan results database 555 even if the results of the diagnostic scan are not displayed in a window of the web browser 535.

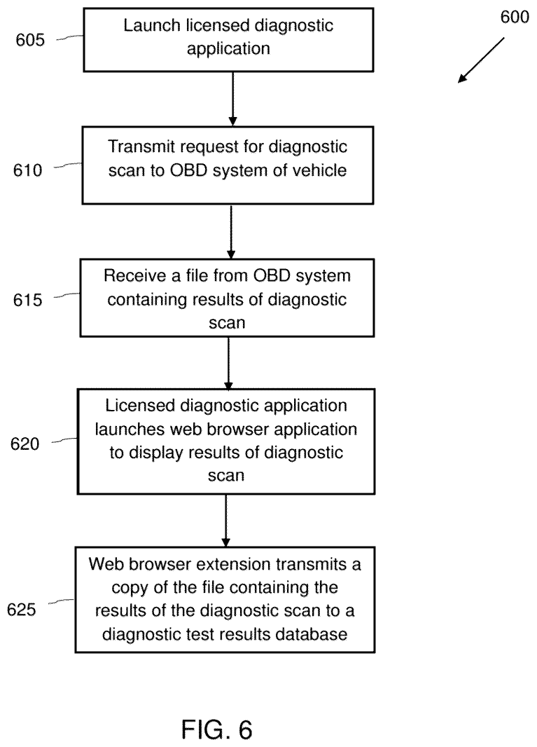

FIG. 6 illustrates an embodiment 600 of a flow diagram for acquiring diagnostic scan results of a vehicle and using a web browser extension to transmit the diagnostic scan results to a diagnostic scan results database. Embodiments in accordance with claimed subject matter may include all of, less than, or more than operations 605 through 620. Also, the order of operations 605 through 620 is merely an example order. For example, a method in accordance with embodiment 600 may be performed by a computing device having one or more processors. At operation 605, a licensed diagnostic application may be launched on a computing device, such as on computing device 520 shown in embodiment 500 of FIG. 5. At operation 610, a request for a diagnostic scan is transmitted from the computing device to an OBD system of the vehicle. At operation 615, a file may be received by the licensed diagnostic application from the OBD system, where the file contains results of the diagnostic scan, At operation 620, the licensed diagnostic application may launch a web browser to display results of the diagnostic scan. At operation 625, a web browser extension of the web browser may transmit a copy of the file containing the results of the diagnostic scan to a diagnostic scan results database.

An RPA process may provide a one-click feature which automatically selects answers to any questions asked by a particular diagnostic scan application. Accordingly, instead of a user having to manually provide such answers to the questions, the RPA process may instead automatically answer the questions. The user may click one time to initiate the RPA process and then walk away from a computing device which runs a diagnostic scan application while the RPA process controls the diagnostic scan application. After initiating and/or completing the diagnostic scan, the diagnostic scan application may subsequently launch a web browser to display results which a web browser extension of the web browser automatically copies to a database, as discussed above with respect to embodiment 500 of FIG. 5.

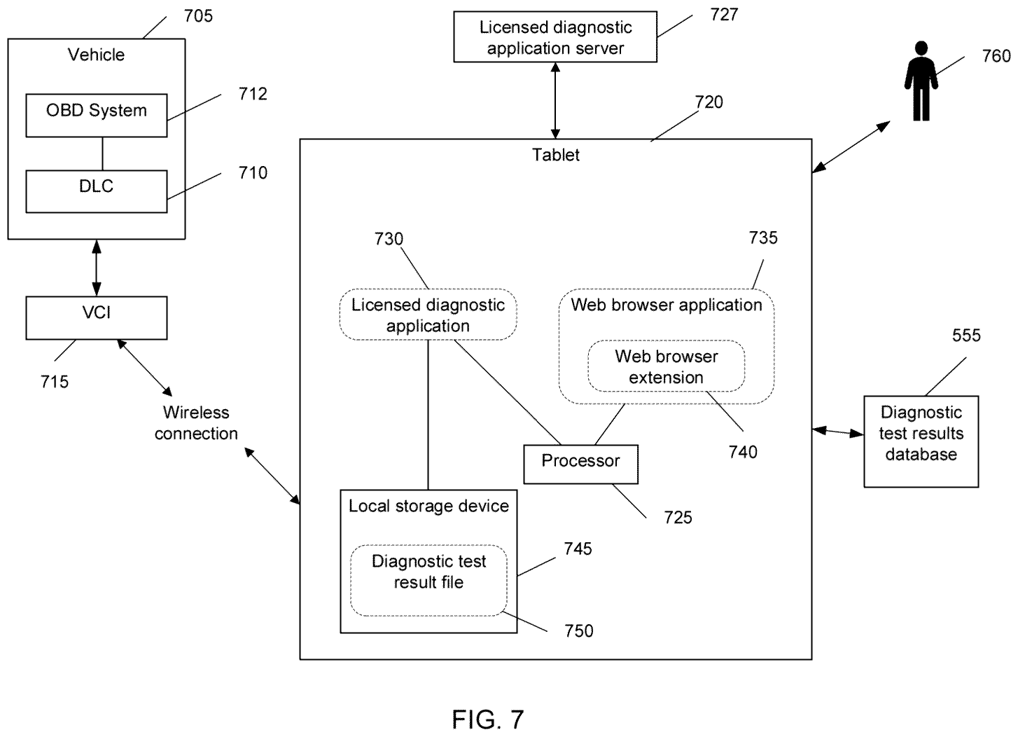

If a dismantler has obtained a vehicle, such as by purchasing the vehicle or otherwise obtaining custody thereof, the dismantler may perform a diagnostic scan on the vehicle prior to dismantling the vehicle, such as discussed above. In some embodiments, a dismantler may use a tablet or a smart phone to initiate a diagnostic scan. If a tablet is used, a diagnostic application may be stored on the tablet, such as within a memory or storage device thereof. In the case of a tablet, a web browser might not have access to a location in memory in which a file of results of a diagnostic scan are stored on the tablet. For example, a tablet or smart phone may, for security purposes, prevent a web browser from accessing a file of diagnostic scan results received by a licensed diagnostic application from a vehicle after the vehicle has performed diagnostic tests. Accordingly, in an embodiment in which a tablet or smart phone has a licensed diagnostic application stored thereon which is used to initiate a diagnostic scan of a vehicle, an architecture for capturing diagnostic scan results and sending them to a remote diagnostic scan results database may differ from that described above with respect to embodiment 500 of FIG. 5. For example, a feature which enables a remote access feature of a licensed diagnostic application may be employed to allow a web browser to access information displayed within a GUI of licensed diagnostic application, such as is described below with respect to FIGS. 7-14B.

FIG. 7 illustrates an embodiment 700 of a system for initiating a diagnostic scan on a vehicle 705 from a tablet 720 and transmitting the results of the diagnostic scan to a diagnostic results database 755 via use of a web browser extension 740 of a web browser 735. In embodiment 700, a user 760, such as a technician, may utilize tablet 720, for example, to initiate a diagnostic scan of vehicle 705. Although embodiment 700 is described with respect to the use of a tablet 720, it should be appreciated that in some implementations, a smart phone may be utilized instead of a tablet 720. Tablet 720 may comprise a wireless portable electronic computing device. User 760 may cause tablet 720 to launch a licensed diagnostic application 730 to initiate a diagnostic scan on a vehicle 705 manufactured by one or more predetermined automobile manufacturers. Licensed diagnostic application 730 may have several features, one of which allows the licensed diagnostic application 730 running on tablet 720 to be controlled remotely so that, for example, a different technician potentially located hundreds of miles away may remotely control licensed diagnostic application 730 and view results of a diagnostic scan of vehicle 705. Automobiles are becoming increasingly more complex over time. As a result, some technicians at a local workshop may not have the level of expertise sufficient to diagnose problems with vehicle 705 and/or know how to address such problems. Accordingly, a more experienced technician who is potentially located remote from the workshop may instead remotely access and/or control the licensed diagnostic application 730 running on tablet 720 even if a computing device utilized by the remote technician does not also have the licensed diagnostic application 730 stored thereon. Instead, a remote diagnostic feature of licensed diagnostic application 730 may enable the remote technician to remotely access the licensed diagnostic application 730 via a web browser stored on the remote technician's computing device. In such an implementation, because the results are shown in a window of a web browser, a web browser extension of the web browser may be utilized to copy results displayed within the web browser and send those results to a diagnostic scan results database 755.

Although such a remote diagnostic feature may be used to enable a remotely located technician to access the licensed diagnostic application 730, a web browser located on any computing device, such as a web browser 735 located directly on and run by tablet 720 may alternatively be used to access or control licensed diagnostic application 730. Accordingly, user 760 may install web browser 735 on tablet 720, if web browser 735 has not previously been installed thereon.

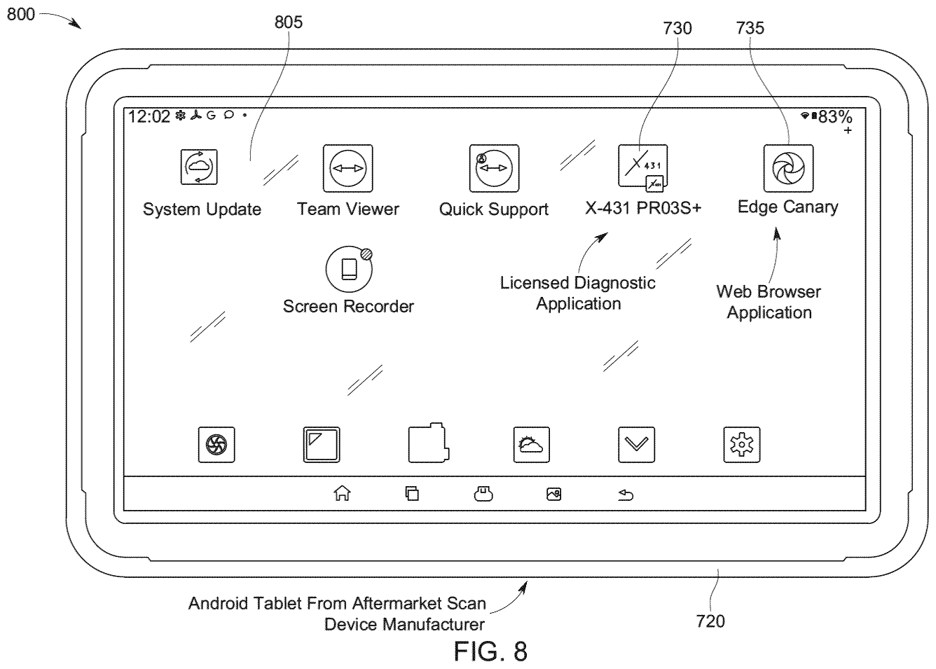

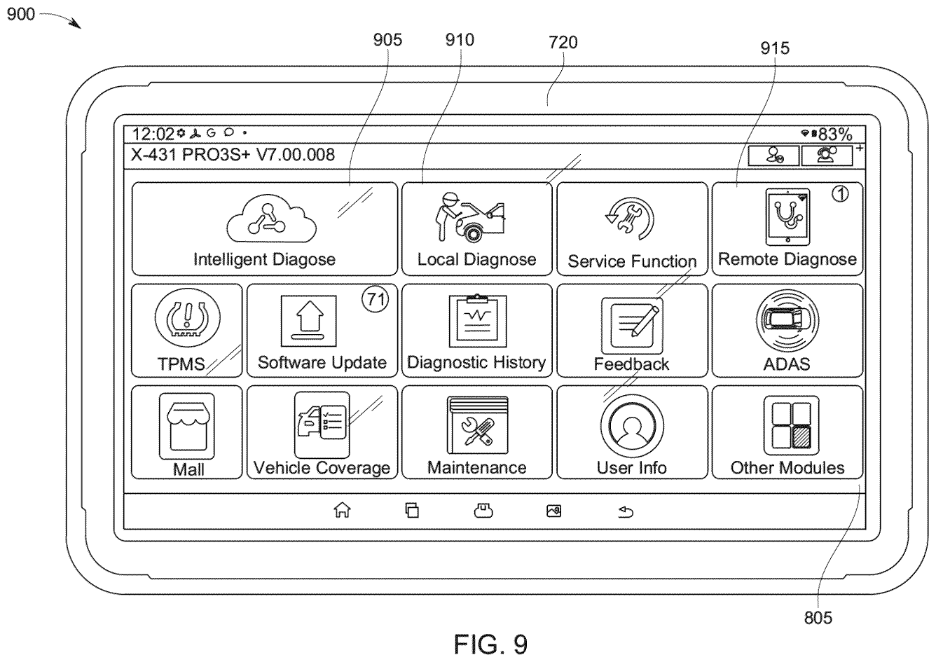

FIG. 8 illustrates an embodiment 800 of a view of a display screen 805 of tablet 720. As shown in embodiment 800, licensed diagnostic application 730 and web browser 735 may be installed on tablet 720. Web browser 735 may be installed on tablet 720 through the use of an app store. For example, if tablet 720 runs the Android™ operating system, table 720 may acquire web browser 735 from the Google Play Store™. User 760 may subsequently launch licensed diagnostic application 730 and may select a remote diagnostic feature of licensed diagnostic application, such as shown below in embodiment 900 of FIG. 9.

FIG. 9 illustrates an embodiment 900 of a window 905 of licensed diagnostic application 730. For example, after user 760 has launched licensed diagnostic application 730, application window 905 may be displayed on display screen 805 of tablet 720. Several options relating to diagnostic scans may be presented to user 760 via application window 905. One of the options is for a local diagnose feature 910. A local diagnose feature 910 may be selected by a technician who is physically located at tablet 720 and desires to perform a diagnostic scan on vehicle 705 through the use of licensed diagnostic application 730. Another option is a remote diagnose feature 915. Remote diagnose feature 915 may be selected if user 760 desires to access licensed diagnostic application 730 through the use of a web browser 735, or if the user 760 desires to allow some other person to remotely access licensed diagnostic application 730 from a web browser running on a computing device other than tablet 720. In this embodiment, user 760 may select remote diagnose feature 915. After selecting remote diagnose feature, user 760 is enabled to access licensed diagnostic application 730 through the use of a web browser 735. In order to use the remote diagnose feature 915, user 760 may select remote diagnose feature 915 of licensed diagnostic application 730 and then the user 760 or someone else may launch web browser 735 and may access a particular Uniform Resource Locator (URL) associated with the remote diagnose feature 915 in order to access licensed diagnostic application 730 from a web browser 735 which is not associated with or otherwise in direct communication with licensed diagnostic application 730.

After selecting the remote diagnose feature 915, a technician, such as the same user 760 or a different person using a computing device different from tablet 720, may log into a WEB Remote Diagnose platform and a specified URL and may input an ID or serial number identifying the tablet 720 in order to remotely connect to licensed diagnostic application 730.

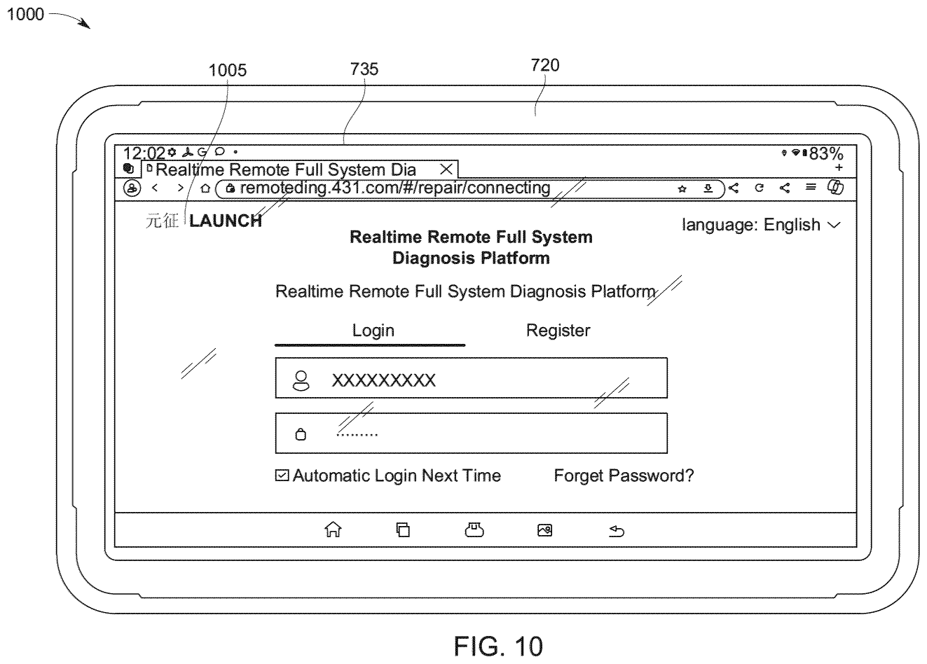

FIG. 10 illustrates an embodiment 1000 of a window 1005 of web browser 735 displayed on tablet 720. As shown, a remote system diagnosis platform is displayed in window 1005. The user 760 may provide a login and password in order to log into the platform in order to remotely run or access licensed diagnostic application 730 through the remote diagnose feature 915.

Referring back to embodiment 700 of FIG. 7, user 760 may provide one or more user inputs via licensed diagnostic application 730 to cause VCI 715 to provide a request for a diagnostic scan to an OBD system 712 via DLC 710 of vehicle 705. Results of the requested diagnostics scan of vehicle 705 may be transmitted from OBD system 712 via the DLC 710 to VCI 715 and from VCI 715 to licensed diagnostic application 730. For example, the licensed diagnostic application 730 may present the results of the diagnostic test in a display screen of licensed diagnostic application 730. If the user 760 is utilizing the remote diagnose feature 915 of licensed diagnostic application 730, data comprising display screens from licensed diagnostic application 730 may be transmitted to a web client such as licensed diagnostic application server 727, and the data is subsequently sent from licensed diagnostic application server 727 to web browser 735.

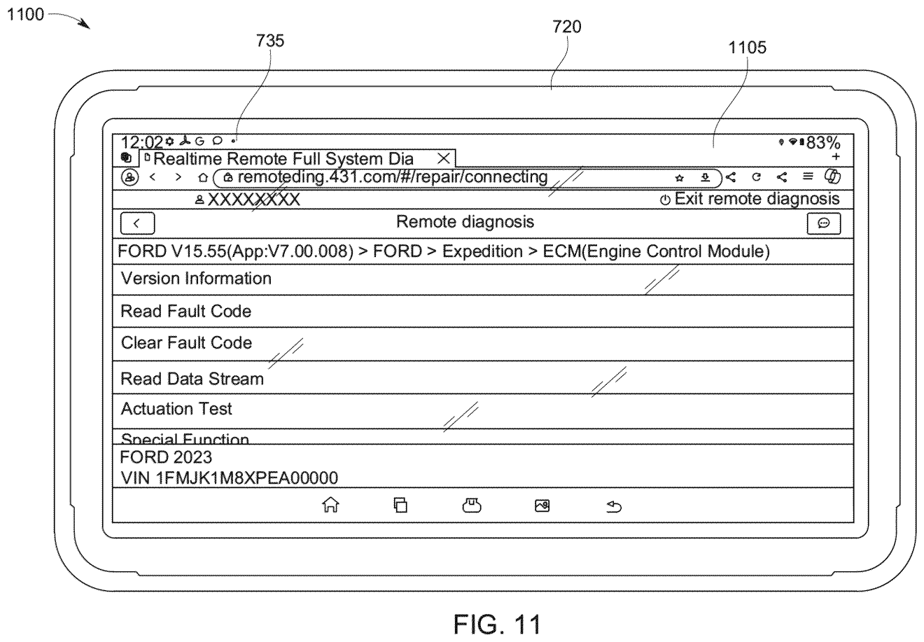

FIG. 11 illustrates an embodiment 1100 of a window 1105 of web browser 735 displayed on tablet 720. As shown, a page of remote system diagnosis platform is displayed in window 1105. There are several selectable menu options in window 1105, such as “Version Information,” “Read Fault Code,” “Clear Fault Code,” “Read Data Stream,” “Actuation Test, and “Special Function,”to name just a few examples among many possible selectable options.

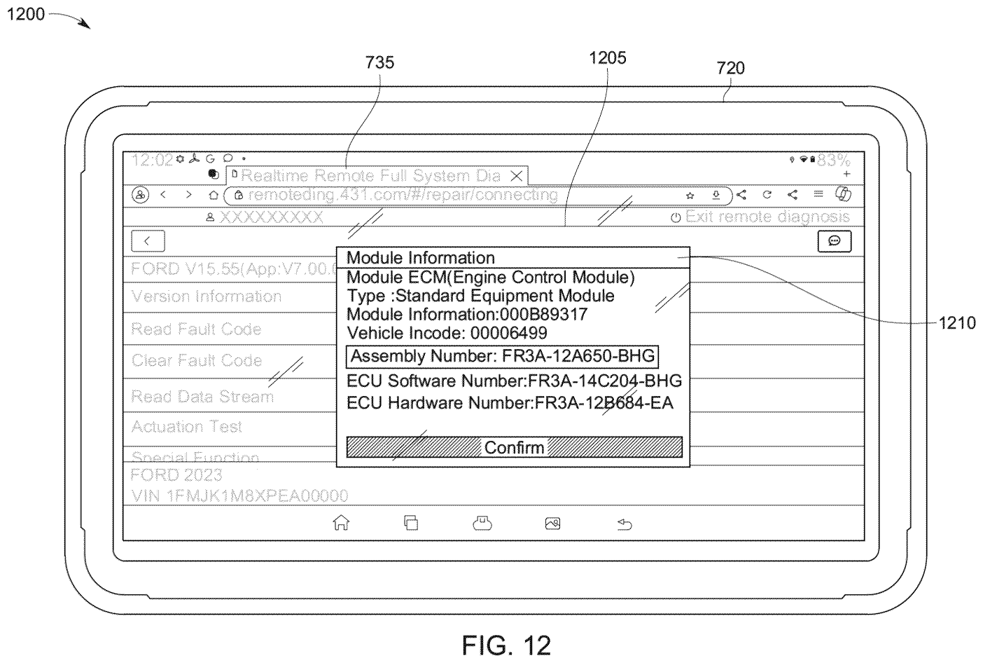

FIG. 12 illustrates an embodiment 1200 of a window 1205 of web browser 735 displayed on tablet 720. As shown, a page of the remote system diagnosis platform is displayed in window 1205. A popup window 1210 may be displayed in response to user 760 selecting a “Version Information” menu option in the previous window 1105 of embodiment 1100 shown in FIG. 11. Popup window 1210 may display various information or data regarding a particular module, such as the ECM (Engine Control Module) in embodiment 1200. Popup window 1210 also indicates a type of module, which is listed as “Standard Equipment Module” in this example. A “Module Information” item is listed as being “000B9317.” A “Vehicle Incode” item is listed as being “00006499.” As “Assembly Number” item is listed as being “FR3A-12A650-BHG.” An “EDU Software Number” item is listed as being “FR3A-14C204-BHG.” An “CU Hardware Number” is listed as being “FR3A-12B684-EA.”

Referring back to FIG. 7, web browser extension 740 may monitor information, such as web pages, displayed or accessed via web browser 735 from the remote diagnose feature 915 and may detect data having a predetermined format or naming structure. In one aspect, diagnostic results or other information relating to vehicle 705 may selectively be acquired from results displayed within a window of web browser 735. For example, information such as is shown in popup window 1205 of FIG. 12, may have a predetermined content, format, and/or naming structure. For example, predetermined content may include key-value pairs such as a combination of particular numbers or characters, such as ASCII characters. As shown in popup window 1210 of FIG. 12, the “Assembly Number,” “ECU Software Number,” and “ECU Hardware Number” items each include corresponding information starting with the character string, “FRA3-”. Web browser extension 740 may be programmed to identify character strings which start with this “FRA3-” character string such that if this string is identified within data displayed in a window of licensed diagnostic application 730 such that when that character string is located in the window, information presented within the window may be copied by web browser extension 740 and transmitted to diagnostic scan results database 755 for storage.

In some embodiments, other information may be displayed in a window of web browser 735, such as VIN number which has a predetermined alphanumeric format. For example, a VIN number may be composed of 16 or 17 characters (digits and capital letters) which act as a unique identifier for vehicle 705. If a VIN number is displayed within a window of web browser 735, web browser extension 740 may capture or copy all, or a select amount, of data displayed within the window along with the detected VIN number and may transmit such data to diagnostic scan results database 755. Other data may be listed within a predetermined naming format, such as the name for a particular diagnostic test. For example, results of a diagnostic test for a scan of a braking system module of vehicle 705 may have a name such as “DTC01,” results of a diagnostic test for a scan of an anti-lock brake system module may have a name such as “DTC02,” to name just two examples among many. If the results of “DTC01” are display in a window of web browser 735 and the name “DTC01” is displayed, web browser extension 740 may identify the use of this name starting with the characters “DTC” and may copy the data displayed in the window and transmit such information to diagnostic scan results database 755. The date/time at which a particular diagnostic test was performed may also be displayed along with the test results, for example. Diagnostic scan results database 755 may store the scan results received for vehicle 705 in a manner so that test results received are associated with the VIN number and/or other identify information for vehicle 705. Moreover, a date/time at which each test was performed may also be stored in diagnostic scan results database 755. In some embodiments, a date/time at which each test result was received by diagnostic scan results database 755 may also be stored.

In the case of a dismantler having the web browser 735 and the licensed diagnostic software 730 running on the same device, such as tablet 720, it is a challenge for user 760 to keep in mind all of the possible electrical components that may be in the vehicle 705 and whether an electrical component has been scanned or should be scanned. However, assistance may be provided to user 760 through the use of web browser extension 740 changing what the web browser 735 displays about an electrical component (e.g., whether the electrical component has been scanned, whether the electrical component should be scanned, a count of the total number of potential electrical components to scan, a count of the total number of electrical components that have been scanned, and/or a duration of time to scan, to name just a few examples among many).

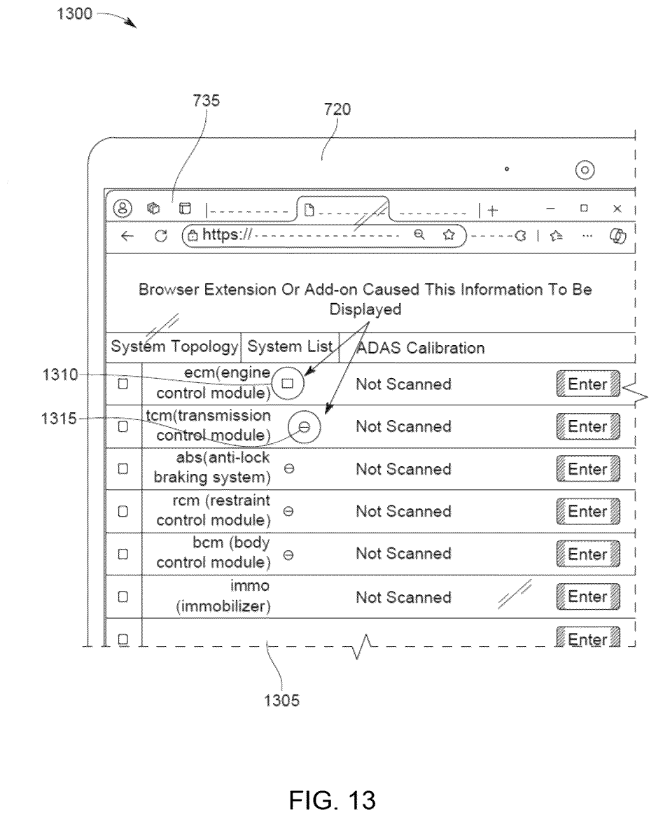

FIG. 13 illustrates an embodiment 1300 of a window 1305 of web browser 735 displayed on tablet 720. As shown, a page of the remote system diagnosis platform showing a list of systems in the vehicle 705 as week as which systems have been scanned may be displayed in window 1305. In one embodiment, only the list of systems in vehicle 705 may normally be displayed in window 1305. However, web browser extension 740 may be programmed to cause additional information to be displayed to indicate which systems have been scanned. In embodiment 1300, an identifier, such as a square icon 1310, may be displayed which indicates that a part number and diagnostic trouble code for the engine control module has been gathered. On the other hand, a different identifier, such as a “no entry” circle icon 1315, may indicate that the transmission control module has not been scanned.

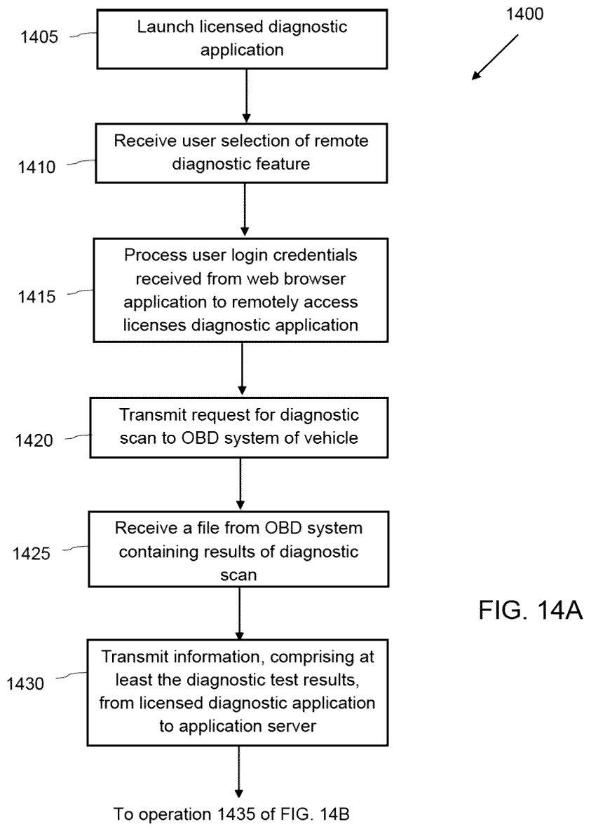

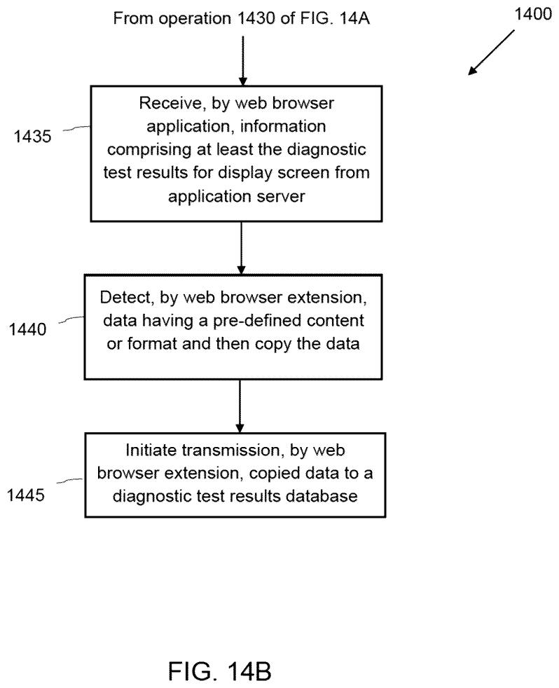

FIGS. 14A and 14B collectively illustrate an embodiment 1400 of a flow diagram for acquiring diagnostic scan results of a vehicle, accessing the diagnostic scan results in a web browser remote from a licensed diagnostic application, and using a web browser extension to copy and transmit at least a portion of the diagnostic scan results to a diagnostic scan results database. Embodiments in accordance with claimed subject matter may include all of, less than, or more than operations 1405 through 1445. Also, the order of operations 1405 through 1445 is merely an example order. For example, a method in accordance with embodiment 1400 may be performed by a computing device having one or more processors.

At operation 1405, a licensed diagnostic application may be launched on a computing device, such as on tablet 720 shown in embodiment 700 of FIG. 7. At operation 1410, a user selection of a remote diagnosis feature may be received. At operation 1415, user login credentials received from a web browser may be processed to enable the user to remotely access the licensed diagnostic application. In some embodiments, the web browser and the licensed diagnostic application may be executed or otherwise run on the same computing device. In other embodiments, the web browser may be executed or run on a first computing device, whereas the licensed diagnostic application may be executed or run on a second computing device different from the first computing device. At operation 1420, a request for a diagnostic scan is transmitted from the licensed diagnostic application of tablet 720 to an OBD system of a vehicle. At operation 1425, a file may be received by the licensed diagnostic application from the OBD system, where the file contains results of the diagnostic scan. At operation 1430, information, comprising at least the diagnostic test results, may be transmitted from the licensed diagnostic application to an application server. At operation 1435, the web browser may receive the information comprising at least the diagnostic test results from the application server. At operation 1440, the web browser extension may detect information having a pre-defined name prefix or format and may subsequently copy the data. At operation 1455, the web browser extension may transmit the copied data to a diagnostic test results database.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals, files or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A process comprising:
transmitting a request for a diagnostic scan of a vehicle from a diagnostic application running on a computing device to an On-Board Diagnostic (OBD) system of the vehicle;
receiving a file, by the diagnostic application, from the OBD system of the vehicle in response to the OBD system performing the diagnostic scan;
launching, by the diagnostic application, a web browser application to display results stored in the file;
copying, by a web browser extension of the web browser application, the file to generate a file copy; and
transmitting, by the web browser extension, the file copy to a diagnostic test results database.

2. The process of claim 1, further comprising receiving a user input to request that the diagnostic scan be performed on the vehicle.

3. The process of claim 2, wherein in response to receiving the user input to request that the diagnostic scan be performed on the vehicle, a series of questions regarding the vehicle are presented on a graphical user interface (GUI) of the computing device, the diagnostic application requesting that answers to the questions be provided prior to the diagnostic application transmitting the request for the diagnostic scan to the OBD system of the vehicle.

4. The process of claim 3, wherein the answers to the questions are provided by a Robotic Process Automation (RPA) tool.

5. The process of claim 1, wherein the transmitting of the request for the diagnostic scan of the vehicle comprises transmitting the request, from the diagnostic application to a Vehicle Communication Interface (VCI) and from the VCI to an On-Board Diagnostic II (OBD2) port of the vehicle.

6. The process of claim 1, wherein the diagnostic application comprises a licensed application which is unaffiliated with a provider of the web browser application.

7. A system, comprising:
a computing device having a processor to:
execute a diagnostic application to:
initiate transmission of a request for a diagnostic scan of a vehicle to an On-Board Diagnostic (OBD) system of the vehicle;
process a file received from the OBD system of the vehicle in response to the OBD system performing the diagnostic scan;
launch a web browser application;
execute the web browser application to:
display results stored in the file;
copy, by a web browser extension of the web browser application, the file to generate a file copy; and
initiate transmission, by the web browser extension, the file copy to a diagnostic test results database.

8. The system of claim 7, wherein the computing device comprises a user interface to receive a user input to request that the diagnostic scan be performed on the vehicle.

9. The system of claim 8, the computing device further comprising a graphical user interface (GUI), and wherein in response to the computing device receiving the user input to request that the diagnostic scan be performed on the vehicle, a series of questions regarding the vehicle are presented on the GUI, the diagnostic application requesting that answers to the questions be provided prior to the diagnostic application transmitting the request for the diagnostic scan to the OBD system of the vehicle.

10. The system of claim 7, wherein the initiating of the transmission of the request for the diagnostic scan of the vehicle comprises initiating the transmission of the request, from the diagnostic application to a Vehicle Communication Interface (VCI) and from the VCI to an On-Board Diagnostic II (OBD2) port of the vehicle.

11. An article, comprising:
a non-transitory storage medium comprising machine-readable instructions executable by a processor to perform:
transmitting a request for a diagnostic scan of a vehicle from a diagnostic application running on a computing device to an On-Board Diagnostic (OBD) system of a vehicle;
receiving a file, by the diagnostic application, from the OBD system of the vehicle in response to the OBD system performing the diagnostic scan;
launching, by the diagnostic application, a web browser application to display results stored in the file;
copying, by a web browser extension of the web browser application, the file to generate a file copy; and
transmitting, by the web browser extension, the file copy to a diagnostic test results database.

12. The article of claim 11, wherein the machine-readable instructions are further executable by the processor to process a received user input to request that the diagnostic scan be performed on the vehicle.

13. The article of claim 11, wherein the machine-readable instructions are further executable by the processor to, responsive to receiving the user input to request that the diagnostic scan be performed on the vehicle, present a series of questions regarding the vehicle on a graphical user interface (GUI) of the computing device, the diagnostic application requesting that answers to the questions be provided prior to the diagnostic application transmitting the request for the diagnostic scan to the OBD system of the vehicle.

14. The article of claim 13, wherein the machine-readable instructions are further executable by the processor to provide the answers to the questions by a Robotic Process Automation (RPA) tool.

15. The article of claim 11, wherein the diagnostic application comprises a licensed application which is unaffiliated with a provider of the web browser application.

16. A process comprising:
executing a web browser application on a first computing device to perform:
implementing a remote diagnose feature of a diagnostic application to control the diagnostic application in a remote mode, wherein the web browser application is unaffiliated with the diagnostic application;
processing user login credentials via a user input to remotely access the diagnostic application;
remotely controlling the diagnostic application to:
transmit a request for a diagnostic scan to an On-Board Diagnostic (OBD) system of a vehicle;
process a file comprising diagnostic test results, the file being received from the OBD system of the vehicle in response to the OBD system performing the diagnostic scan;
initiate transmission of information comprising at least the diagnostic test results from the diagnostic application to an application server;
receiving, by the web browser application, the information comprising at least the diagnostic test results from the application server;
detecting, by a web browser extension of the web browser application, data within the received information having a pre-defined content or format and copying the data; and
initiating transmission, by the web browser extension, of the copied data to a diagnostic test results database.

17. The process of claim 16, wherein the user input comprises the request that the diagnostic scan of the OBD system of the vehicle be performed.

18. The process of claim 17, wherein in response to receiving the request that the diagnostic scan of the OBD system of the vehicle be performed, a series of questions regarding the vehicle are presented on a graphical user interface (GUI) of the computing device, the diagnostic application requesting that answers to the questions be provided prior to the diagnostic application transmitting the request for the diagnostic scan to the OBD system of the vehicle.

19. The process of claim 18, wherein the answers to the questions are provided by a Robotic Process Automation (RPA) tool.

20. The process of claim 19, wherein in response to the web browser application receiving the diagnostic scan results, presenting a display screen, by the web browser, indicating a list of electrical components of the vehicle.

21. The process of claim 20, wherein the web browser extension is programmed to present one or more identifiers on the display screen to indicate one or more items of the list of electrical components which have either been scanned or not yet scanned.

22. The process of claim 16, wherein the web browser extension is configured to automatically transmit the copied data to the diagnostic test results database.

23. The process of claim 16, wherein the diagnostic application is executed on a second computing device.

24. A system, comprising:
a first computing device having a processor to:
execute a web browser application to:
implement a remote diagnose feature of a diagnostic application to control the diagnostic application in a remote mode, wherein the web browser application is unaffiliated with the diagnostic application;
process user login credentials via a user input to remotely access the diagnostic application;
remotely control the diagnostic application to:
transmit a request for a diagnostic scan to an On-Board Diagnostic (OBD) system of a vehicle;
process a file received from the OBD system of the vehicle in response to the OBD system performing the diagnostic scan;
initiate transmission of information comprising at least the diagnostic test results from the diagnostic application to an application server;
process the information comprising at least the diagnostic test results received from the application server;
detect, by a web browser extension of the web browser application, data within the received information having a pre-defined content or format and copying the data; and
initiate transmission, by the web browser extension, of the copied data to a diagnostic test results database.

25. The system of claim 24, wherein the user input comprises the request that the diagnostic scan of the OBD system of the vehicle be performed.

26. The system of claim 24, wherein the initiating of the transmission of the request for the diagnostic scan of the vehicle comprises initiating the transmission of the request, from the diagnostic application to a Vehicle Communication Interface (VCI) and from the VCI to an On-Board Diagnostic II (OBD2) port of the vehicle.

27. The system of claim 24, wherein in response to the web browser application receiving the diagnostic scan results from the application server, presenting a display screen, by the web browser, indicating a list of electrical components of the vehicle.

28. The system of claim 27, wherein the web browser extension is programmed to present one or more identifiers on the display screen to indicate one or more items of the list of electrical components which have either been scanned or not yet scanned.

29. The system of claim 24, wherein the diagnostic application is executed on a second computing device.

30. An article, comprising:
a non-transitory storage medium comprising machine-readable instructions executable by a processor to perform:
executing a web browser application to:
implement a remote diagnose feature of a diagnostic application to control the diagnostic application in a remote mode, wherein the web browser application is unaffiliated with the diagnostic application;
process user login credentials via a user input to remotely access the diagnostic application;
remotely control the diagnostic application to:
transmit a request for a diagnostic scan to an On-Board Diagnostic (OBD) system of a vehicle;
process a file received from the OBD system of the vehicle in response to the OBD system performing the diagnostic scan;
generate a display screen to present diagnostic scan results;
initiate transmission of information for the display screen to an application server;
process the information comprising at least the diagnostic test results received from the application server;
detect, by a web browser extension of the web browser application, data within the received information having a pre-defined content or format and copying the data; and
initiate transmission, by the web browser extension, of the copied data to a diagnostic test results database.

31. The article of claim 30, wherein the user input comprises the request that the diagnostic scan of the OBD system of the vehicle be performed.

32. The article of claim 30, wherein the machine-readable instructions are further executable by the processor to initiate the transmission of the request, from the diagnostic application to a Vehicle Communication Interface (VCI) and from the VCI to an On-Board Diagnostic II (OBD2) port of the vehicle.

33. The article of claim 30, wherein the machine-readable instructions are further executable by the processor to, in response to the web browser application receiving the diagnostic scan results from the application server, present a display screen, by the web browser application, indicating a list of electrical components of the vehicle.

34. The article of claim 33, wherein the web browser extension is programmed to present one or more identifiers on the display screen to indicate one or more items of the list of electrical components which have either been scanned or not yet scanned.

35. The article of claim 30, wherein the diagnostic application is executed on a second computing device.
